(19) United States
(12) Patent Application Publication
(10) Pub. No.: US 2012/0047790 A1
(43) Pub. Date: Mar. 1, 2012

(54) FISHING LURE WITH VIDEO CAMERA

(75) Inventors: Jamie Hess, Lancaster, PA (US); James Knapp, Jonesville, MI (US)

(73) Assignee: VIDEOOPTX, LLC, Midland, GA (US)

(21) Appl. No.: 13/215,496

(22) Filed: Aug. 23, 2011

Related U.S. Application Data
(60) Provisional application No. 61/376,292, filed on Aug. 24, 2010.

(51) Int. Cl. A01K 85/00

(52) U.S. Cl. 43/42

(57) ABSTRACT

A fishing lure includes a fishing lure body and a waterproof camera. The waterproof camera is operatively connected to the fishing lure body.

### CROSS-REFERENCE TO RELATED APPLICATIONS

Not applicable.

### FIELD OF THE INVENTION

The present invention relates to the field of image recording devices, and more particularly, the present invention relates to a fishing lure having a camera that is operatively connected to the body of the fishing lure.

### BACKGROUND OF THE INVENTION

Digital still cameras and digital video cameras are well known. Mass adoption of these devices in the consumer marketplace has driven demand for versions that are smaller and lighter, such that they may be easily transported. This circumstance allows users to easily and conveniently take photographs and make video recordings of a wide range of outdoor activities.

One outdoor activity that does not lend itself to easy and convenient filming is fishing. This is, of course, due to the fact that much of the action takes place underwater. Thus, while the proliferation of small and convenient digital still cameras and digital video cameras has allowed average users to photograph and make video recordings of fishing trips from an above-water perspective, underwater filming has remained unapproachable from the perspective of a typical consumer.

It would be desirable to provide an apparatus by which underwater still photographs and video recordings could be made easily and conveniently while fishing.

### SUMMARY OF THE INVENTION

A fishing lure having a camera operatively connected to the body of the fishing lure is taught herein. The camera may be a digital still camera or a digital video camera.

### BRIEF DESCRIPTION OF THE DRAWINGS

The description herein makes reference to the accompanying drawings wherein like reference numerals refer to like parts throughout the several views, and wherein:

FIG. 1 is a perspective view showing a fishing lure according to the present invention;

FIG. 2 is a sectional view showing the fishing lure according to the present invention;

FIG. 3 is a perspective view showing a camera of the fishing lure of the present invention;

FIG. 4 is a block diagram showing the camera;

FIG. 5 is a sectional view of a fishing lure according to a first alternative embodiment of the invention;

FIG. 6 is a sectional view of a fishing lure according to a second alternative embodiment of the invention; and

FIG. 7 is a sectional view of a fishing lure according to a third alternative embodiment of the invention.

### DETAILED DESCRIPTION

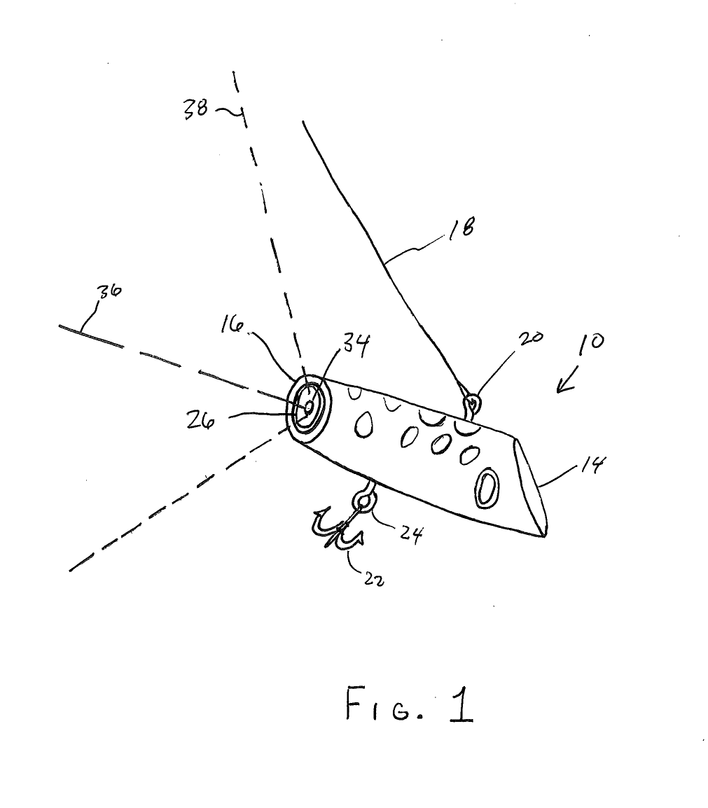

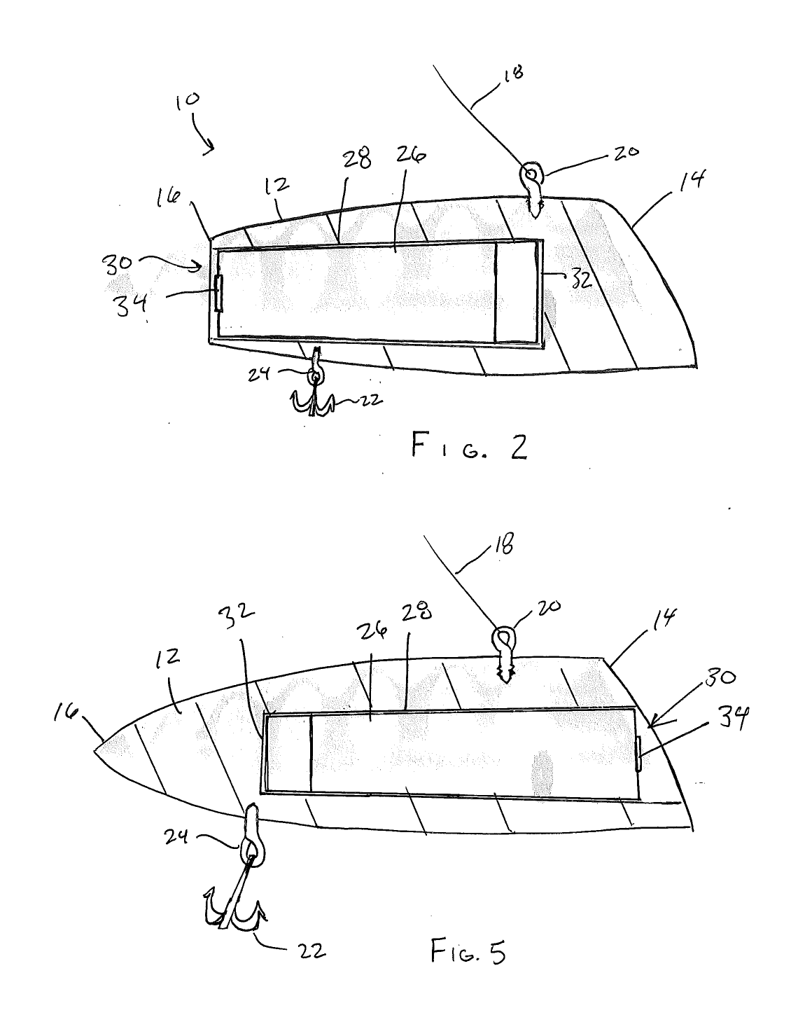

FIGS. 1-2 show a fishing lure 10 according to the present invention. The fishing lure 10 has a substantially monolithic body 12 that extends from a front end 14 to a rear end 16. The body 12 of the fishing lure 10 may be painted or otherwise marked or colored to simulate a fish or other bait, and thus, the fishing lure 10 may include details such as eyes or a lighter-colored underside so that the fishing lure 10 closely resembles fish or other manner of bait.

The fishing lure 10 is attachable to a fishing line 18 using a connector 20, such as an eyelet. One or more hooks 22 may be directly connected to the body 12 of the fishing lure 10 or may be attached to the body 12 using connectors 24 such as eyelets.

The body 12 of the fishing lure 10 may be fabricated from known materials, such as plastics, resins, or wood. Furthermore, the body 12 of the fishing lure 10 may include a core and skin that are fabricated from differing materials. The body 12 of the fishing lure may be buoyant or non-buoyant, as desired for a particular application. Weights (not shown) or other features may be incorporated into the body 12 of the fishing lure 10 in order to provide desired balance characteristics for the fishing lure 10.

In connection with the foregoing, it is noted that the structural configuration of the fishing lure 10 described thus far is not critical. Rather, fishing lures 10 may be provided having various designs and configurations within the scope of the invention subject to a combination of the features that will be further described herein.

The fishing lure 10 of the invention is characterized by provision of a structure by which a camera 26 may be integrated into the fishing lure 10 or mounted to the fishing lure 10. In the embodiment shown in FIGS. 1-2, the camera 26 is detachably mounted to the body 12 of the fishing lure 10 by provision of a cavity 28 having an open end 30 within the body 12 of the fishing lure 10.

In order to accommodate the camera 26 therein, the cavity 28 may be a substantially cylindrical bore that extends into the body 12 of the fishing lure 10 from the rear end 16 thereof toward the front end 14 thereof In this manner, the open end 30 of the cavity 28 is positioned at the rear end 16 of the body 12 of the fishing lure 10. Also, an internal end wall 32 may be formed within the body 12 of the fishing lure 10 to define the innermost extent of the cavity 28 and define the limit for maximum insertion of the camera 26 into the body 12 of the fishing lure 10. The internal end wall 32 may be positioned with respect to the body 12 of the fishing lure 10 such that a lens 34 of the camera 26 is substantially flush with the rear end 16 of the body 12 of the fishing lure 10.

It should be understood that positioning the camera 26 within the cavity 28 of the body 12 of the fishing lure 10 allows an optical axis 36 of the lens 34 to extend rearwardly outward from the body 12 of the fishing lure 10. Thus, a field of vision 38 of the camera 26 exists rearward of the fishing lure 10 when it is being used. While this configuration is not necessary, it may be desirable, because fish often strike fishing lures from behind.

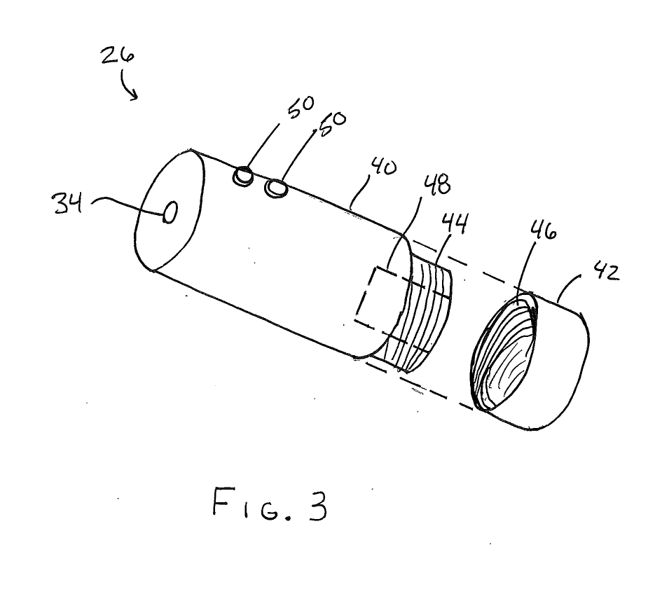

As shown in FIG. 3, the camera 26 includes a two-part housing comprised of a first housing portion 40 and a second housing portion 42. When the first housing portion 40 and the second housing portion 42 are connected together using complementary threaded portions 44, 46 on each of the first and second housing portions 40, 42, the camera 26 is substantially waterproof. In addition, a gasket (not shown), such as an O-ring, may be provided between the first housing portion 40 and the second housing portion 42 to further prevent water infiltration into the camera 26.

The lens 34 of the camera 26 is positioned on the first housing portion 40 of the camera 26, at a longitudinal end thereof. Opposite the lens 34, an input/output interface 48 is provided at the other longitudinal end of the first housing portion 40 and is circumscribed by the threaded portion 44 of the first housing portion 40, such that the input/output interface 48 is disposed adjacent to the second housing portion 42 when the first and second housing portions 40, 42 are connected with respect to one another. Control buttons 50 may also be provided on the camera 26.

As shown in FIG. 4, the lens 34 of the camera 26 provides light to an image sensor 52. The image sensor 52 is a digital image sensor, such as a CMOS or CCD sensor array. The image sensor 52 is electrically connected to image recording hardware that is operable to control the image sensor 52 and to process and store either or both of digital still images and digital video that is received by the image recording hardware from the image sensor 52.

The image recording hardware includes an image processor 54 that converts the signal output by the image sensor 52 into a digital image signal. The image processor 54 is shown herein as separate from the image sensor 52, but it should be understood that the image processor 54 could be integrated with the image sensor 52, such that the image sensor 52 and the image processor 54 could be fabricated on a single chip or PCB.

The image recording hardware further includes a controller 56 that is electrically connected to the image processor 54. The controller 56 may also be electrically connected to the control buttons 50, a storage media 58, and the input/output interface 48. The control buttons 50 control operation of the camera 26. The storage media 58 is a non-volatile memory unit on which images or video may be stored. The storage media 58 may be an integral part of the camera 26 or may be removable media such as an SD card or any other suitable removable memory, either now known or later created. The input/output interface 48 allows the camera 26 to be connected to another device, such as a computer. For example, the input/output interface 48 may be a connector for a wired connection, such as a USB connection. Alternatively, the input/output interface 48 could operate wirelessly by technology such as Bluetooth or Wi-Fi. Of course, other suitable wireless data transfer technologies, either now known or later created, may also be utilized.

In use, the camera 26 is assembled by connecting the first and second housing portions 40, 42, such that the camera 26 is made watertight The camera 26 is then inserted into the cavity 28 within the body 12 of the fishing lure 10. The fishing lure 10 may then be used as a normal fishing lure is used, including connection of the fishing lure 10 to the fishing line 18 and fishing hooks 22, as well as submersion of the fishing lure 10 and utilization of the fishing lure 10 for catching fish. Once the fishing lure 10 is retrieved, the video or images captured by the camera 26 may be retrieved using the input/output interface 48, such as by a wired connection of the input/output interface 48 to a computer.

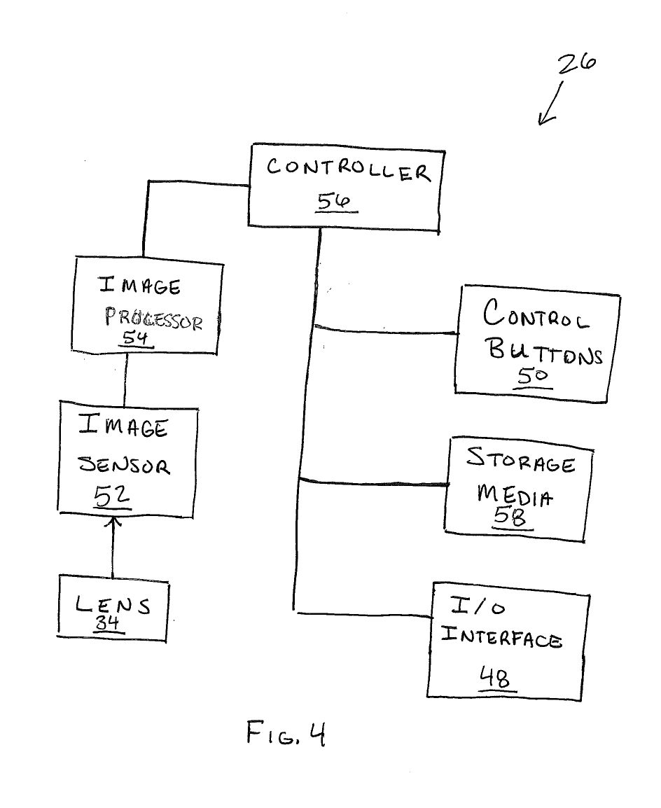

A first alternative embodiment of the fishing lure 10 is shown in FIG. 5. As shown in FIG. 5, the cavity 28 may be positioned within the body 12 of the fishing lure 10 such that the open end 30 of the cavity 28 coincides with the front end 14 of the body 12 of the fishing lure 10.

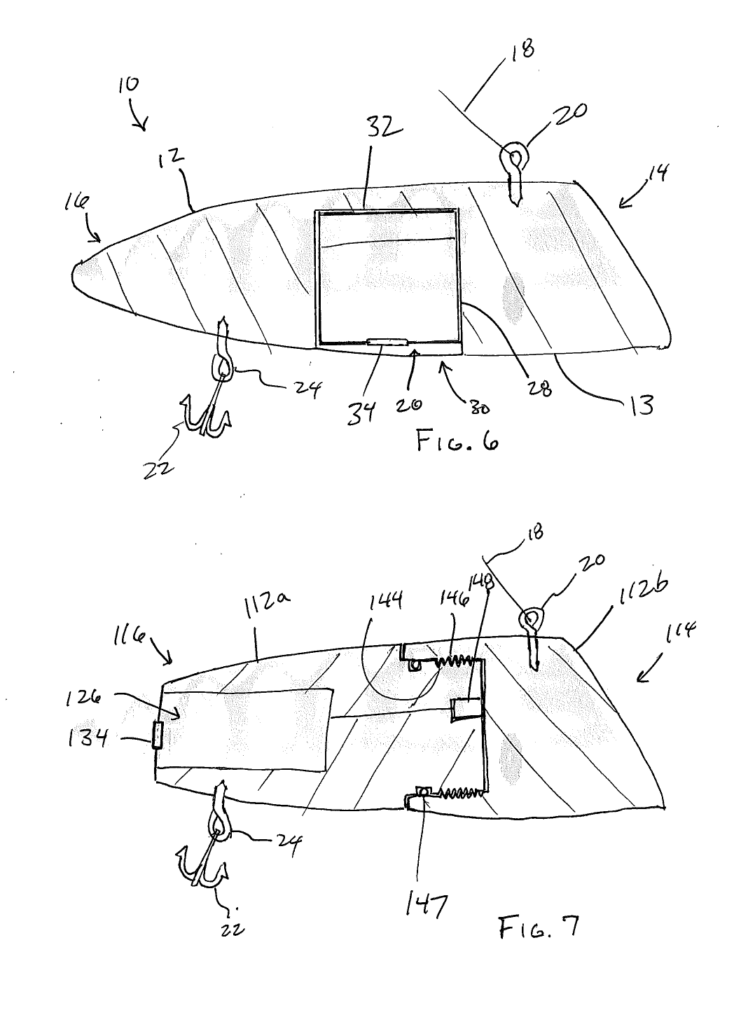

A second alternative embodiment of the fishing lure 10 is shown in FIG. 6. The fishing lure 10 of FIG. 6 is similar to those previously described, with the exception that the cavity 28 is configured within the body 12 of the fishing lure 10 such that the open end 30 of the cavity 28 is positioned on a lateral side surface 13 of the body 12 of the fishing lure 10. The lateral side surface 13 could be a top surface, bottom surface, or left or right surface of the body 12 of the fishing lure 10.

FIG. 7 shows a third alternative embodiment of the invention. A fishing lure 110 has a two-part body having a first body portion 112a and a second body portion 112b. The first and second body portions 112a, 112b of the fishing lure 110 are connected together by complementary threaded portions 144, 146. An O-ring 147 may also be provided to seal the first body portion 112a with respect to the second body portion 112b.

A camera 126 is provided integrally within the first body portion 112a of the fishing lure 110. A lens 134 of the camera 126 is positioned on an exterior surface of the first body portion 112a of the fishing lure 110, such as at a rear end 116 of the fishing lure 110. The other components of the camera 126 are similar to those described in connection with the fishing lure 10 and as shown in FIG. 4, with the exception that the input/output interface 148 is positioned at the interface of the first body portion 112a and the second body portion 112b of the fishing lure 110. Thus, the input/output interface 148 is circumscribed by the threaded portions 144, 146 of the first and second body portions 112a, 112b of the fishing lure 110. The threaded portions 144, 146 and the O-ring 147 prevent water from reaching the input/output interface 148 when the first and second body portions 112a, 112b of the fishing lure 110 are assembled with respect to one another.

Use of the first, second, and third alternative embodiments of the invention is substantially similar to use of the embodiment shown in FIGS. 1-4.

While the invention has been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A fishing lure, comprising:
a fishing lure body; and
a waterproof camera operatively connected to the fishing lure body.
